(19) United States
(12) Patent Application Publication
(10) Pub. No.: US 2024/0314574 A1
(43) Pub. Date: Sep. 19, 2024

(54) DYNAMIC RESOURCE SHARING BASED ON LOCATION AND TIME OF DAY

(71) Applicant: T-MOBILE INNOVATIONS LLC, Overland Park, KS (US)

(72) Inventor: Nagi A. Mansour

(21) Appl. No.: 18/121,415

(22) Filed: Mar. 14, 2023

(51) Int. Cl. H04W 16/10; H04L 5/14

(52) U.S. Cl. CPC H04W 16/10; H04L 5/14

(57) ABSTRACT

According to aspects herein, methods and systems for dynamic resource sharing based on location and time of day are provided. Historical data corresponding to a node providing service to one or more UEs is initially collected and aggregated over a period of time. Based on trends identified in the historical data corresponding to uplink usage and downlink usage, a downlink/uplink ratio of the node is dynamically adjusted. This enables the node to anticipate the appropriate downlink/uplink ratio for a particular location and a particular time of day, resulting in efficiency gains that can be realized by the UEs.

### SUMMARY

Embodiments of the technology described herein are directed to, among other things, systems and methods for dynamic resource sharing are provided. More particularly, based on location and time of day, a downlink/uplink ratio of the node can be dynamically adjusted. Historical data corresponding to a node providing service to one or more UEs is initially collected and aggregated over a period of time. Based on trends identified in the historical data corresponding to uplink usage and downlink usage, a downlink/uplink ratio of the node is dynamically adjusted. This enables the node to anticipate the appropriate downlink/uplink ratio for a particular location and a particular time of day, resulting in efficiency gains that can be realized by the UEs.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Implementations of the present disclosure are described in detail below with reference to the attached drawing figures, wherein:

FIG. 1 illustrates a diagram of an exemplary network environment in which implementations of the present disclosure may be employed;

FIG. 2A depicts a wireless network environment incorporating a dynamic resource sharing system experiencing heavy downlink usage patterns, in accordance with aspects herein;

FIG. 2B depicts a wireless network environment incorporating a dynamic resource sharing system experiencing heavy uplink usage patterns, in accordance with aspects herein;

FIG. 3 is a flow diagram of an example method for providing dynamic resource sharing based on location and time of day, in accordance with some aspects of the technology described herein; and

FIG. 4 depicts an example computing environment suitable for use in implementation of the present disclosure.

### DETAILED DESCRIPTION

The subject matter of embodiments of the invention is described with specificity herein to meet statutory requirements. However, the description itself is not intended to limit the scope of this patent. Rather, it is contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:

| | |
|---|---|
| 3G | Third-Generation Wireless Technology |
| 4G | Fourth-Generation Cellular Communication System |
| 5G | Fifth-Generation Cellular Communication System |
| BRS | Broadband Radio Service |
| CD-ROM | Compact Disk Read Only Memory |
| CDMA | Code Division Multiple Access |
| EIRP | Equivalent Isotropically Radiated Power |
| eNodeB | Evolved Node B |
| GIS | Geographic/Geographical/Geospatial Information |
| | System |
| gNodeB | Next Generation Node B |
| GPRS | General Packet Radio Service |
| GSM | Global System for Mobile communications |
| iDEN | Integrated Digital Enhanced Network |
| DVD | Digital Versatile Discs |
| EEPROM | Electrically Erasable Programmable Read Only |
| | Memory |
| LED | Light Emitting Diode |
| LTE | Long Term Evolution |
| MD | Mobile Device |
| MIMO | Multiple Input Multiple Output |
| mMIMO | Massive Multiple-Input Multiple-Output |
| MMU | Massive Multiple-Input Multiple-Output Unit |
| NEXRAD | Next-Generation Radar |
| NR | New Radio |
| NSA | Nonstandalone |
| OOBE | Out-of-Band-Emission |
| PC | Personal Computer |
| PCS | Personal Communications Service |
| PDA | Personal Digital Assistant |
| RAM | Random Access Memory |
| RAT | Radio Access Technology |
| RET | Remote Electrical Tilt |
| RF | Radio-Frequency |
| RFI | Radio-Frequency Interference |
| R/N | Relay Node |
| RNR | Reverse Noise Rise |
| ROM | Read Only Memory |
| RRU | Remote Radio Unit |
| RSRP | Reference Transmission Receive Power |
| RSRQ | Reference Transmission Receive Quality |
| RSSI | Received Transmission Strength Indicator |
| SA | Standalone |
| SINR | Single-to-Interference-Plus-Noise Ratio |
| SNR | Transmission-to-noise ratio |
| SON | Self-Organizing Networks |
| TDMA | Time Division Multiple Access |
| TXRU | Transceiver (or Transceiver Unit) |
| UE | User Equipment |
| UMTS | Universal Mobile Telecommunications Systems |
| WCD | Wireless Communication Device (interchangeable |
| | with UE) |

Further, various technical terms are used throughout this description. A definition of such terms can be found in, for example, Newton's Telecom Dictionary by H. Newton, 31st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the technology may take the form of, among other things: a method, system, or set of instructions embodied on one or more computer-readable media. Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include but are not limited to information-delivery media,

RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point.

Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB or a New Radio (NR) connection). In this regard, typically only one active uplink connection can occur per frequency. The base station may include one or more sectors served by individual transmitting/receiving components associated with the base station (e.g., antenna arrays controlled by an EnodeB). These transmitting/receiving components together form a multi-sector broadcast arc for communication with mobile handsets linked to the base station.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point.

A time division duplex (TDD) system uses time division multiplexing to separate uplink and downlink signals. It emulates full duplex communication over a half-duplex communication link. TDD provides flexibility in situations where there is asymmetry of uplink and downlink data rates. As the amount of uplink data increases, more communication capacity can be allocated by the network operator, and when the traffic load is lighter, capacity can be decreased by the network operator. The same concepts also apply to downlink signals.

There are times of day and/or areas where devices transmit more data than they receive, typically when using uplink heavy applications, and would benefit from a heavy uplink TDD pattern. For example, some applications, such a video conferencing, uploading pictures or video to sites, and online gaming, may require significant uplink data. There are other times of day and/or areas where devices transmit less than they receive and would benefit from a heavy downlink pattern. However, conventional systems are unable to predict or dynamically and automatically adjust to changes in usage.

The present disclosure is directed to systems, methods, and computer readable media for providing dynamic resource sharing. More particularly, a downlink/uplink ratio of the node can be dynamically adjusted based on location and time of day. Historical data corresponding to a node providing service to one or more UEs is initially collected and aggregated over a period of time. Based on trends identified in the historical data corresponding to uplink usage and downlink usage, a downlink/uplink ratio of the node is dynamically adjusted. This enables the node to anticipate the appropriate downlink/uplink ratio for a particular location and a particular time of day, resulting in efficiency gains that can be realized by the UEs.

According to aspects of the technology described herein, a method for providing dynamic resource sharing based on location and time of day is provided. The method comprises receiving historical data corresponding to a node providing service to one or more UEs. The method also comprises, based on the historical data, dynamically adjusting a downlink/uplink ratio of the node.

According to further aspects of the technology described herein, one or more computer-readable media having computer-executable instructions embodied thereon that, when executed by at least one computing device, cause the computing device to perform operations for providing dynamic resource sharing based on location and time of day is provided. The operations comprise receiving historical data corresponding to a node providing service to one or more UEs. The operations also comprise, based on the historical data, dynamically adjusting a downlink/uplink ratio of the node.

According to even further aspects of the technology described herein, a system for providing dynamic resource sharing based on location and time of day is provided. The system comprises one or more UEs. The system also comprises a node configured to wirelessly communicate with the one or more UEs. The node is configured to receive historical data corresponding to a node providing service to the one or more UEs. The node is also configured to, based on the historical data, dynamically adjust a downlink/uplink ratio of the node.

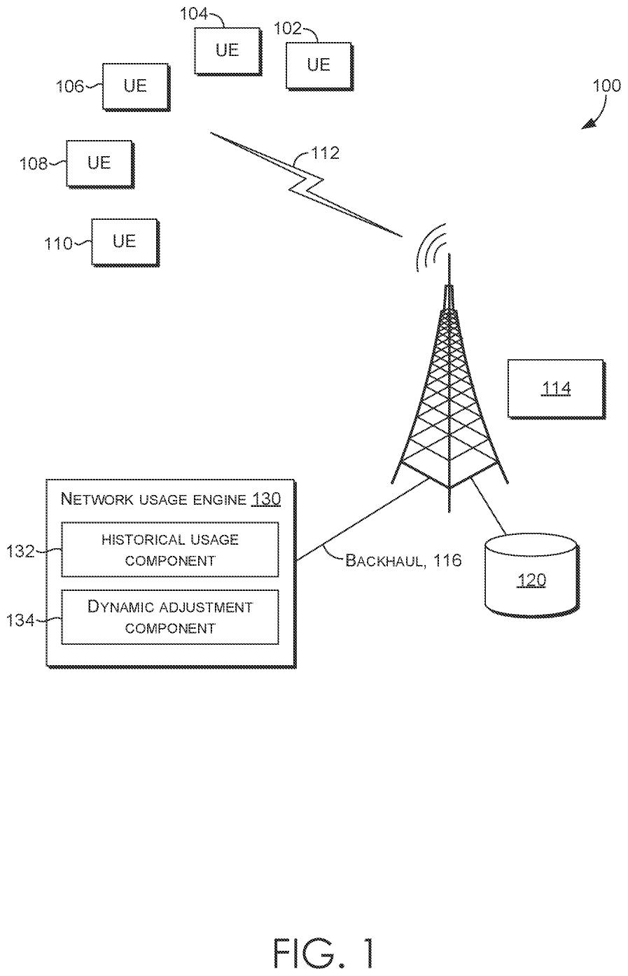

FIG. 1 depicts a wireless network environment incorporating a time division duplex (TDD) system in which implementations of the present disclosure may be employed. Such a network environment is illustrated and designated generally as network environment 100. Network environment 100 is not to be interpreted as having any dependency or requirement relating to any one or combination of components illustrated.

Network environment 100 includes user devices (UE) 102, 104, 106, 108, and 110, access point 114 (which may be a cell site, base station, or the like), and one or more communication channels 112. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device) that communicates via wireless communications with the access point 214 in order to interact with a public or private network.

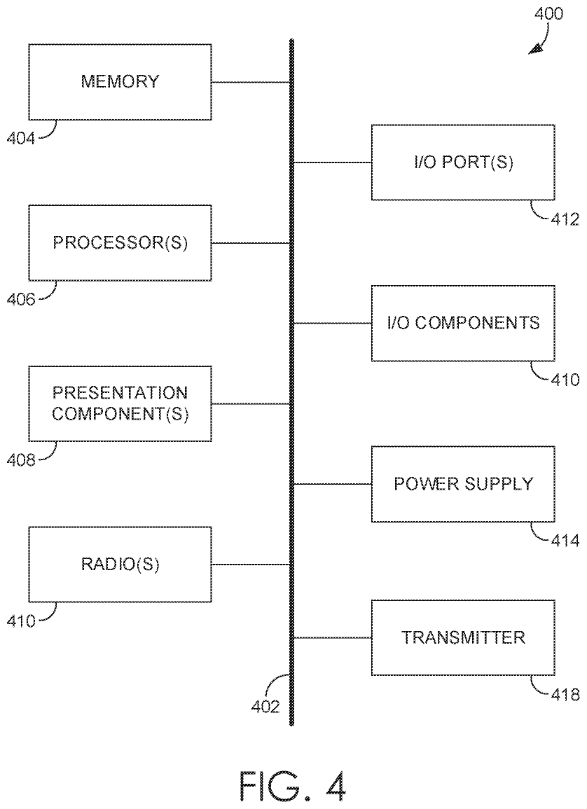

In some aspects, each of the UEs 102, 104, 106, 108, and 110 may correspond to computing device 400 in FIG. 4. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, or any other type of network.

In some cases, UEs 102, 104, 106, 108, and 110 in network environment 100 can optionally utilize one or more communication channels 112 to communicate with other computing devices (e.g., a mobile device(s), a server(s), a personal computer(s), etc.) through access point 114. The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, NR, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), or a 5G network.

In some implementations, access point 114 is configured to communicate with a UE, such as UEs 102, 104, 106, 108, and 110, that are located within the geographic area, or cell, covered by radio antennas of access point 114. An access point 114 may include one or more base stations, base transmitter stations, radios, antennas, antenna arrays, power amplifiers, transmitters/receivers, digital signal processors, control electronics, GPS equipment, and the like. In particular, access point 114 may selectively communicate with the user devices using dynamic beamforming.

As shown, access point 114 is in communication with a network component 130 and at least a network database 120 via a backhaul channel 116. As the UEs 102, 104, 106, 108, and 110 with the access point 114, access point 114 may collect and store the data corresponding to uplink usage and downlink usage of the UEs 102, 104, 106, 108, and 110 at a network database 120. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the data stored in the network database 120 current. The data can include, for example, uplink and downlink usage, geographic location, time of day, available networks, and the like.

The network usage engine 130 generally facilitates dynamic resource sharing based on location and time of day and comprises a historical usage component 132 and a dynamic adjustment component 134. Although the network usage engine 130 is shown as a single component comprising the historical usage component 132 and the dynamic adjustment component 134, it is also contemplated that each of the usage component 132 and a dynamic adjustment component 134 may reside at different locations, be its own separate entity, and the like, within the home network carrier system, or as a component of one of UEs 102, 104, 106, 108, and 110.

The historical usage component 132 generally collects historical data from UEs 102, 104, 106, 108, and 110. As mentioned the data may include uplink and downlink usage, geographic location, time of day, available networks, and the like. Moreover, the historical usage component 132 may periodically refresh the data within a predetermined time interval which may be in seconds, minutes, hours, days, months, years, and the like.

The adjustment component 134 generally dynamically adjusts a downlink/uplink ratio of the access point 114. For example, using the historical data collected by the historical usage component, the adjustment component may identify trends in the historical data. The trends may correspond to a time of day or a particular area serviced by the access point 114. In response, the adjustment component 134 dynamically adjusts the downlink/uplink ratio of the access point 114 corresponding to the identified trend.

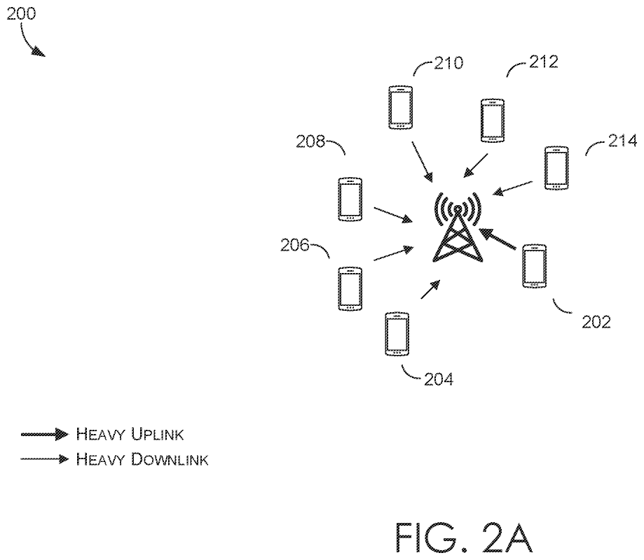

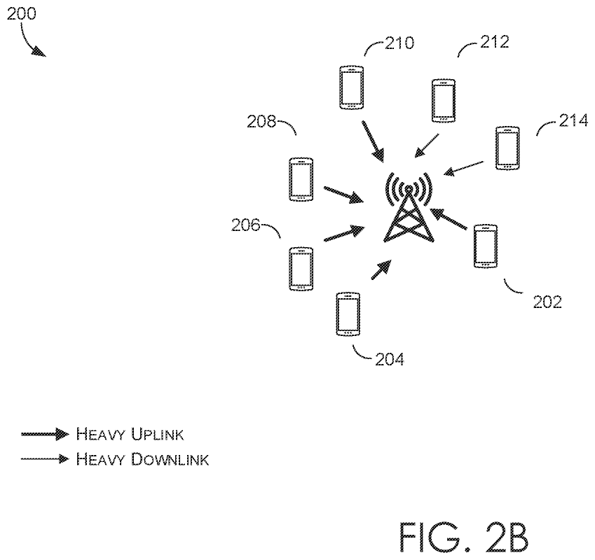

FIG. 2A illustrates depicts a wireless network environment 200 incorporating a dynamic resource sharing system experiencing heavy downlink usage patterns, in accordance with aspects herein. The wireless network environment 200 includes UE 202 exhibiting heavy uplink patterns and UEs 204, 206, 208, 210, 212, 214 exhibiting heavy downlink patterns. In this scenario, an adjustment component (such as the adjustment component 134 of FIG. 1) would likely maintain the normal operating downlink/uplink ratio (e.g., 80:20) of the access point. If the downlink/uplink ratio had been previously adjusted to accommodate a heavy uplink pattern (e.g., 70:30), an adjustment component may dynamically adjust the downlink/uplink ratio of the access point 114 to its normal operating downlink/uplink ratio (e.g., 80:20).

FIG. 2B illustrates depicts the wireless network environment 200 (at a different time of day) incorporating a dynamic resource sharing system experiencing heavy uplink usage patterns, in accordance with aspects herein. The wireless network environment 200 includes UEs 202, 204, 206, 208, 210 exhibiting heavy uplink patterns and UEs 212, 214 exhibiting heavy downlink patterns. In this scenario, an adjustment component (such as the adjustment component 134 of FIG. 1) may dynamically adjust the downlink/uplink ratio of the access point to increase efficiency for the current usage pattern (e.g., 70:30). As can be appreciated, although not shown, if there is a particular area that is exhibiting a heavy uplink or downlink pattern, the downlink/uplink ratio for one or more beams providing service to that area may be dynamically adjusted in the same manner.

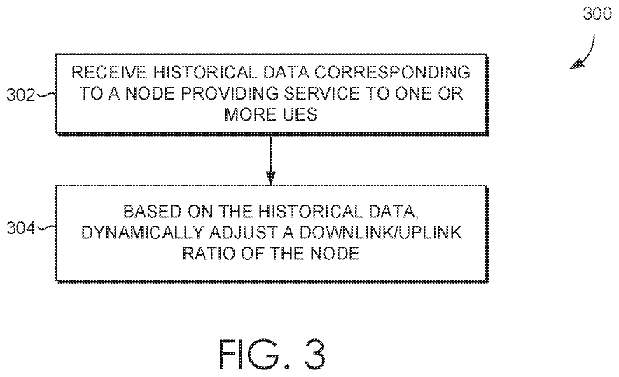

Referring to FIG. 3, a flow diagram is provided depicting a method 300 providing dynamic resource sharing based on location and time of day, in accordance with aspects of the present invention. Method 300 may be performed by any computing device (such as computing device described with respect to FIG. 4) with access to a network usage engine (such as the one described with respect to FIG. 1) or by one or more components of the network environment described with respect to FIG. 1 (such as UEs 102, 104, 106, 108, 110 access point 114, or network usage engine 130).

Initially, at step 302, historical data corresponding to a node providing service to one or more UEs is received. In aspects, the historical data comprises uplink usage and downlink usage, geographic location, time of day, available networks, and the like. The node may provide TDD communication links to the one or more UEs.

Based on the historical data, at step 304, a downlink/uplink ratio of the node is dynamically adjusted. In some aspects, the historical data may reveal a trend. For example, the trend may indicated that during a particular time of day, there is a heavy uplink or downlink usage pattern. Additionally or alternatively, the trend may indicate that a particular area serviced by the node exhibits a heavy uplink usage pattern. In response, the downlink/uplink ratio of the node is dynamically adjusted accordingly.

FIG. 4 depicts a diagram of an exemplary network environment in which implementations of the present disclosure may be employed. In FIG. 4, computing device 400 includes bus 402 that directly or indirectly couples the following devices: memory 404, one or more processors 406, one or more presentation components 408, input/output (I/O) ports 412, I/O components 410, radio 416, transmitter 418, and power supply 414. Bus 402 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component such as a display device to be one of I/O components 410. Also, processors, such as one or more processors 406, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. Memory 404 may be removable, nonremovable, or a combination thereof. Exemplary memory includes solid-state memory, hard drives, optical-disc drives, etc. Computing device 400 includes one or more processors 406 that read data from various entities such as bus 402, memory 404 or I/O components 410. One or more presentation components 408 present data indications to a person or other device. Exemplary one or more presentation components 408 include a display device, speaker, printing component, vibrating component, etc. I/O ports 412 allow computing device 400 to be logically coupled to other devices including I/O components 410, some of which may be built into computing device 400. Illustrative I/O components 410 include a microphone, joystick, game pad, satellite dish, scanner, printer, wireless device, etc.

The radio 416 represents one or more radios that facilitate communication with a wireless telecommunications network. While a single radio 416 is shown in FIG. 4, it is contemplated that there may be more than one radio 416 coupled to the bus 402. In aspects, the radio 416 utilizes a transmitter 418 to communicate with the wireless telecommunications network. It is expressly conceived that a computing device with more than one radio 416 could facilitate communication with the wireless telecommunications network via both the first transmitter 418 and an additional transmitters (e.g. a second transmitter). Illustrative wireless telecommunications technologies include CDMA, GPRS, TDMA, GSM, and the like. The radio 416 may additionally or alternatively facilitate other types of wireless communications including Wi-Fi, WiMAX, LTE, 3G, 4G, LTE, 5G, NR, VOLTE, or other VoIP communications. As can be appreciated, in various embodiments, radio 416 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for providing dynamic resource sharing based on location and time of day, the method comprising:
receiving historical data corresponding to a node providing service to one or more UEs; and
based on the historical data, dynamically adjusting a downlink/uplink ratio of the node.

2. The method of claim 1, wherein the historical data comprises uplink usage and downlink usage.

3. The method of claim 1, wherein the node provides time division duplex (TDD) communication links to the one or more UEs.

4. The method of claim 1, further comprising identifying a trend in the historical data.

5. The method of claim 4, wherein the trend corresponds to a time of day.

6. The method of claim 4, wherein the trend corresponds to a particular area serviced by the node.

7. The method of claim 4, wherein the dynamically adjusting corresponds to the trend.

8. One or more computer-readable media having computer-executable instructions embodied thereon that, when executed by at least one computing device, cause the computing device to perform operations for providing dynamic resource sharing based on location and time of day, the operations comprising:
receiving historical data corresponding to a node providing service to one or more UEs; and
based on the historical data, dynamically adjusting a downlink/uplink ratio of the node.

9. The one or more computer-readable media of claim 8, wherein the historical data comprises uplink usage and downlink usage.

10. The one or more computer-readable media of claim 8, wherein the node provides time division duplex (TDD) communication links to the one or more UEs.

11. The one or more computer-readable media of claim 8, further comprising identifying a trend in the historical data.

12. The one or more computer-readable media of claim 11, wherein the trend corresponds to a time of day.

13. The one or more computer-readable media of claim 11, wherein the trend corresponds to a particular area serviced by the node.

14. The one or more computer-readable media of claim 11, wherein the dynamically adjusting corresponds to the trend.

15. A system for providing dynamic resource sharing based on location and time of day, the system comprising:
one or more user equipment (UEs); and
a node configured to wirelessly communicate with the one or more UEs, wherein the node is configured to:
receive historical data corresponding to a node providing service to the one or more UEs; and
based on the historical data, dynamically adjust a downlink/uplink ratio of the node.

16. The system of claim 15, wherein the historical data comprises uplink usage and downlink usage.

17. The system of claim 15, wherein the node provides time division duplex (TDD) communication links to the one or more UEs.

18. The system of claim 15, further comprising identifying a trend in the historical data.

19. The system of claim 18, wherein the trend corresponds to a time of day or a particular area serviced by the node.

20. The system of claim 18, wherein the dynamically adjusting corresponds to the trend.
